(19) United States
(12) Patent Application Publication
(10) Pub. No.: US 2026/0231227 A1
(43) Pub. Date: Aug. 6, 2026

(54) METHOD AND APPARATUS FOR UE OUTPUT POWER CONDITION FOR SELECTION OF THE NUMBER OF PRACH REPETITIONS

(71) Applicant: Nokia Technologies Oy, Espoo (FI)

(72) Inventors: Alessio MARCONE, Munich (DE); Marco MASO, Massy (FR); Nhat-Quang NHAT, Massy (FR); Amir Mehdi AHMADIAN TEHRANI, Munich (DE)

(21) Appl. No.: 19/152,372

(22) PCT Filed: Feb. 14, 2024
(86) PCT No.: PCT/IB2024/051389

§ 371 Date: Jul. 30, 2025

Related U.S. Application Data
(60) Provisional application No. 63/446,455, filed on Feb. 17, 2023.

(51) Int. Cl. H04W 74/0833; H04B 17/318; H04W 52/36

(52) U.S. Cl. CPC H04W 74/0833; H04B 17/328; H04W 52/367

(57) ABSTRACT

A method comprising measuring, with a user equipment, a received power of a reference signal; determining, with the user equipment, based on the measurement of the received power, that a physical random access channel is to be transmitted with multiple transmissions; determining, with the user equipment, a transmission power of the physical random access channel; determining, with the user equipment, a power threshold; and at least one of: determining that the determined transmission power is less than the power threshold, and sending the physical random access channel with the user equipment without multiple transmissions of the physical random access channel, or determining that the determined transmission power is greater than the power threshold, and sending the physical random access channel with the user equipment with multiple transmissions of the physical random access channel.

### BACKGROUND

### Technical Field

The example and non-limiting embodiments relate generally to physical random access channel transmissions and, more particularly, to physical random access channel repetitions.

### Brief Description of Prior Developments

In 5G NR, two contention based random access (CBRA) procedures are supported; namely, 4-step RACH (Rel-15) and 2-step RACH (Rel-16).

### SUMMARY

The following summary is merely intended to be an example. The summary is not intended to limit the scope of the claims.

In accordance with one aspect, an example method is provided comprising: measuring, with a user equipment, a received power of a reference signal; determining, with the user equipment, based on the measurement of the received power, that a physical random access channel is to be transmitted with multiple transmissions; determining, with the user equipment, a transmission power of the physical random access channel; determining, with a the user equipment, a power threshold; and at least one of:
determining that the determined transmission power is less than the power threshold, and sending the physical random access channel with the user equipment without multiple transmissions of the physical random access channel, or
determining that the determined transmission power is greater than the power threshold, and sending the physical random access channel with the user equipment with multiple transmissions of the physical random access channel.

In accordance with another aspect, an example apparatus is provided comprising: at least one processor; and at least one non-transitory memory storing instructions that, when executed with the at least one processor, cause the apparatus to perform:
measuring, with the apparatus, a received power of a reference signal;
determining, with the apparatus, based on the measurement of the received power, that a physical random access channel is to be transmitted with multiple transmissions;
determining, with the apparatus, a transmission power of the physical random access channel
determining, with the apparatus, a power threshold; and at least one of:
   determining that the determined transmission power is less than the power threshold, and sending the physical random access channel with the apparatus without multiple transmissions of the physical random access channel, or
   determining that the determined transmission power is greater than the power threshold, and sending the physical random access channel with the apparatus with multiple transmissions of the physical random access channel.

In accordance with another aspect, an example embodiment is provided with a non-transitory program storage device readable by an apparatus, tangibly embodying a program of instructions executable with the apparatus for performing operations, the operations comprising:
measuring, with the apparatus, a received power of a reference signal;
determining, with the apparatus, based on the measurement of the received power, that a physical random access channel is to be transmitted with multiple transmissions;
determining, with the apparatus, a transmission power of the physical random access channel
determining, with the apparatus, a power threshold; and
at least one of:
   determining that the determined transmission power is less than the power threshold, and sending the physical random access channel with the apparatus without multiple transmissions of the physical random access channel, or
   determining that the determined transmission power is greater than the power threshold, and sending the physical random access channel with the apparatus with multiple transmissions of the physical random access channel.

In accordance with another aspect, an example apparatus is provided comprising: means for measuring, with the apparatus, a received power of a reference signal; means for determining, with the apparatus, based on the measurement of the received power, that a physical random access channel is to be transmitted with multiple transmissions; means for determining, with the apparatus, a transmission power of the physical random access channel; means for determining, with the apparatus, a power threshold; and means for, at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

In accordance with another aspect, an example apparatus is provided comprising: circuitry configured for measuring, with the apparatus, a received power of a reference signal; circuitry configured for determining, with the apparatus, based on the measurement of the received power, that a physical random access channel is to be transmitted with multiple transmissions; circuitry configured for determining, with the apparatus, a transmission power of the physical random access channel; circuitry configured for determining, with the apparatus, a power threshold; and circuitry configured for, at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

According to some aspects, there is provided the subject matter of the independent claims. Some further aspects are provided in subject matter of the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating a 4-step RACH procedure;

FIG. 3 is a diagram illustrating an example of associating SSB-RSRP with a number of PRACH repetitions;

FIG. 4 is a diagram illustrating a SSB-RSRP adaptation procedure at a second PRACH attempt;

FIG. 5 is a diagram illustrating an example method;

FIG. 6 is a diagram illustrating an example method; and

FIG. 7 is a diagram illustrating an example method;

FIG. 8 is a diagram illustrating an example method;

FIG. 9 is a diagram illustrating an example method;

FIG. 10 is a diagram illustrating an example method; and

FIG. 11 is a diagram illustrating an example method.

### DETAILED DESCRIPTION

The following abbreviations that may be found in the specification and/or the drawing figures are defined as follows:

3GPP third generation partnership project
5G fifth generation
5GC 5G core network
A-MPR additional MPR
AMF access and mobility management function
CE coverage enhanced
CE UE coverage enhanced UE
CP-OFDM cyclic prefix OFDM
CRC cyclic redundancy check
CU central unit
DCI downlink control information
DCI Format 0_1 UL grant configurable by RRC
DFT-s-OFDM discrete Fourier transform spread orthogonal frequency division multiplexing
DU distributed unit
DWS dynamic waveform switching
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDD frequency division duplexing
FDM frequency domain multiplexing
FR1 frequency range 1
FR2 frequency range 2
GC-DCI group common DCI
gNB (or gNodeB) base station for 5G/NR, i.e., a node providing NR user plane and control plane protocol terminations towards the UE, and connected via the NG interface to the 5GC
I/F interface
LSB least significant bit
LTE long term evolution
MAC medium access control
MCS modulation and coding scheme
MIMO multiple input multiple output
MME mobility management entity
MPR maximum power reduction
MSB most significant bit
Msg1 message 1
ng or NG new generation
ng-eNB or NG-eNB new generation eNB
NR new radio
N/W or NW network
OFDM orthogonal frequency division multiplexing
PDCCH physical downlink control channel
PDCP packet data convergence protocol
PDU protocol data unit
PHR power headroom report
PHY physical layer
PRACH physical random access channel
PUSCH physical uplink control channel
QPSK quadrature phase shift keying
RAN radio access network
RACH random access channel
RAPID random access preamble ID
RAR random access response
RA-RNTI random access—radio network temporary identifier
RB, PRB resource block, physical resource block
RSRP reference signal received power
Rel release
RLC radio link control
RNTI radio network temporary identifier
RO rach occasion
RRH remote radio head
RRC radio resource control
RU radio unit
Rx receiver
SDAP service data adaptation protocol
S/P serial-to-parallel
SGW serving gateway
SIB1 system information block 1
SMF session management function
SR scheduling request
SS/PBCH synchronization signal/physical broadcast channel
SSB synchronization signal block
TB transform block
TDD time division duplexing
TEI technical enhancement item
TPC transmit power control
TS technical specification
Tx transmitter
UE user equipment (e.g., a wireless, typically mobile device)
UL uplink
UPF user plane function
WI work item

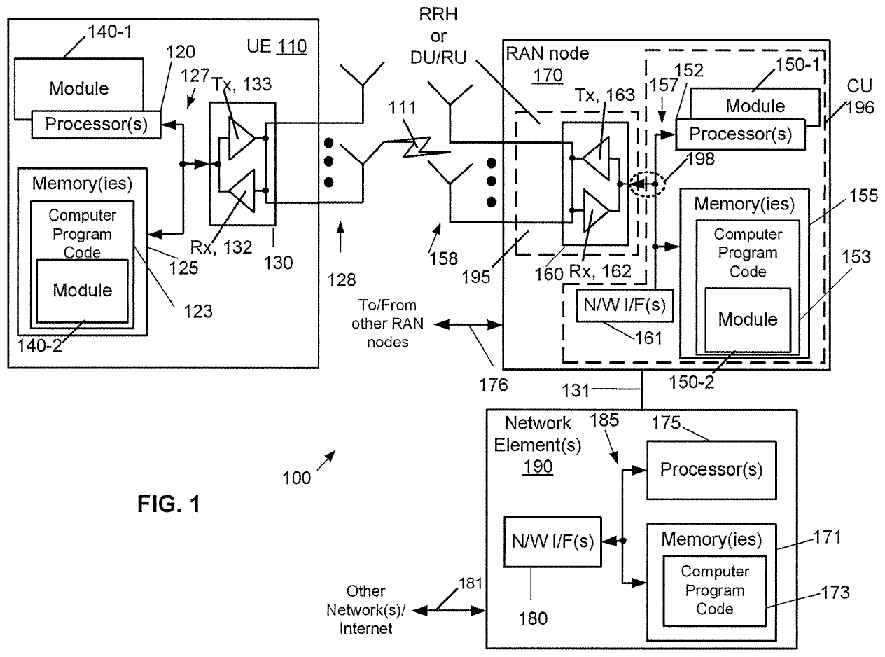

Turning to FIG. 1, this figure shows a block diagram of one possible and non-limiting example in which the examples may be configured to operate in accordance with a cellular communication standard such as, for example, long term evolution, LTE, or fifth generation, 5G, also known as New Radio, NR, 5G-Advanced (i.e. NR Rel-18 and beyond) as well as 6G in which all specified by the 3^{rd} generation partnership project, 3GPP. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Features as described herein are described in relation to 4-step RACH as an example. However, features as described herein are equally applicable to 2-step RACH. As noted above, in 5G NR, two contention based random access (CBRA) procedures are supported, namely 4-step RACH (Rel-15) and 2-step RACH (Rel-16).

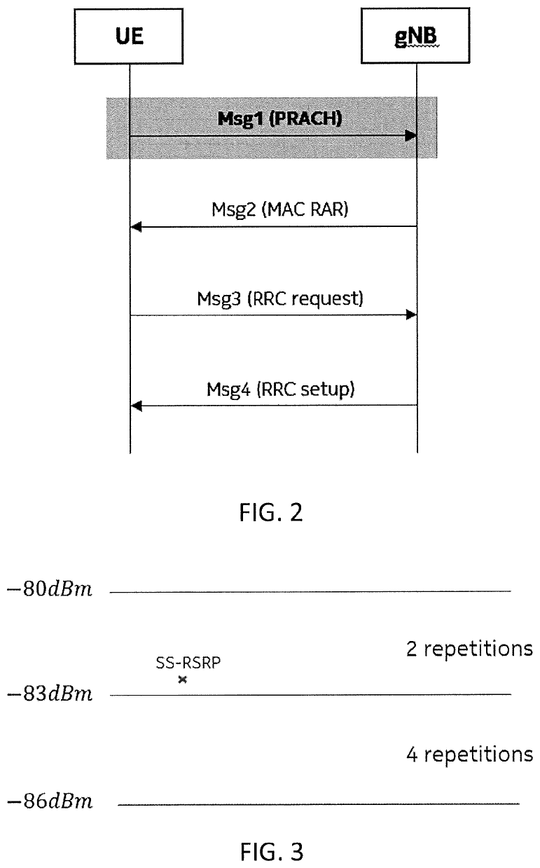

Referring also to FIG. 2, the 4-step RACH procedure can be summarized as follows:
1. Msg1 (a.k.a. PRACH): The UE sends a specific preamble to the gNB via physical random-access channel (PRACH) using a specific resource called RACH occasion (RO).
2. Msg2 (a.k.a. RAR): The gNB replies with a random-access response (RAR) message, which includes the detected preamble ID, the time-advance command, a TC-RNTI, and UL grant for the transmission of Msg3 on PUSCH.
3. Msg3 (a.k.a. RRC request): The UE responds to Msg2 over the scheduled PUSCH with an ID for contention resolution.
4. Msg4 (a.k.a. RRC setup): The gNB transmits the contention resolution message with the contention-resolution ID.

Upon reception of Msg4, the UE sends an ACK on a PUCCH if its contention-resolution ID is carried by Msg4. This completes the 4-step RACH. It is worth noting that prior to Msg1, there is also a preliminary step of sending and receiving the synchronization signal block (SSB), i.e., DL beam sweeping, which is not formally part of the RACH procedure. As a result of this preliminary step, the UE selects the index of the preferred SSB beam and decodes the associated PBCH for MIB, SIB and so on. This index is also used by UE to identify a suitable RO for the preamble transmission (Msg1), according to the SSB-to-RO mapping implicitly conveyed by SIB1.

The 2-step RACH is similar to 4-step RACH presented above, but Msg1 and Msg3 are combined in a MsgA and sent out without waiting for feedback from the UE in between (traditionally Msg2). Similarly, the gNB combines Msg2 and Msg4 into MsgB. It is straightforward to apply the solutions disclosed herein for Msg1, to the preamble/Msg1 part of MsgA.

The following can be noted from the latest work item description for Rel-18 UL coverage enhancements [RP-221858]:

“[...]

● Specify following PRACH coverage enhancements (RAN1, RAN2)

| | |
|---|---|
| ∘ | Multiple PRACH transmissions with same beams for 4-step RACH procedure |
| ∘ | Study, and if justified, specify PRACH transmissions with different beams for 4- |
| | step RACH procedure |
| ∘ | Note 1: The enhancements of PRACH are targeting for FR2, and can also apply |
| | to FR1 when applicable. |
| ∘ | Note 2: The enhancements of PRACH are targeting short PRACH formats, and |
| | can also apply to other formats when applicable. |
| [...]” | |

It can be observed from the above work item description (WID) that Msg1 (PRACH) repetitions (or also called in the work item description multiple PRACH transmissions) will be specified for 5G NR in Rel-18. The terminology PRACH repetitions and multiple PRACH transmissions are used interchangeably herein.

In RAN1 #111, the following agreement was made:

### Agreement

For multiple PRACH transmissions with same Tx beam, at least SSB-RSRP threshold(s) are used to determine the number of PRACH transmissions at least for the first RACH attempt.
   Note: whether to support multiple numbers of PRACH transmissions is separately discussed.

This agreement states that if the SSB-RSRP measured from the UE is lower than one or more configured threshold(s), UE uses such information to determine whether to perform multiple PRACH transmissions, and the number of PRACH transmissions for the first RACH attempt. The different configured thresholds (if multiple thresholds configured) create different SSB-RSRP ranges (or also called coverage enhancement levels), each assigned to a different number of repetitions. Finally, a UE would pick a number of PRACH repetitions based on the measured SSB-RSRP. An example of such operation is illustrated in FIG. 3 (an Example of associating SSB-RSRP with number of PRACH repetitions), wherein two SSB-RSRP thresholds are configured and a UE has measured an SSB-RSRP of-82 dBm belonging to the first SSB-RSRP range and hence would be transmitting PRACH with 2 repetitions.

However, this agreement does not sufficiently address further conditions (“at least SSB-RSRP thresholds are used to determine ...”) to be used by the UE for determining the number of PRACH transmissions for the first or subsequent RACH attempts. Features as described herein complement this agreement. In particular, features as described herein may be used to define further conditions to be used by the UE for determining the number of PRACH transmissions for the first and subsequent RACH attempts.

Multiple PRACH transmissions (or PRACH repetitions) are expensive in terms of network resources as the gNB will have to reserve specific resources (RACH occasions (ROs) or preambles) for UEs transmitting PRACH repetitions different than “legacy” resources utilized from UEs transmitting PRACH without repetitions. This, in turn, means that the number of resources reserved for PRACH repetitions will be minimized by the gNB; increasing the collision probability of UEs transmitting PRACH repetitions. In addition to this, PRACH repetitions will increase the access delay of the UEs; especially when considering that the available resources for PRACH repetitions are not always consecutive in time (e.g. in a Time Division Duplexing (TDD) system). In consideration of such limitations, it is desirable to ensure that a UE is at or at least near maximum power before triggering the PRACH repetitions.

For configuration of the SSB-RSRP thresholds, the gNB may have to estimate an adequate value of the SSB-RSRP threshold by considering the expected output power of a UE for a certain frequency range, to make sure that only UEs at or at least near maximum power transmit PRACH with repetitions. Estimation of the expected UE power is, however, not straightforward since different UEs have different capabilities in terms of available output power.

Based on these considerations, the configured SSB-RSRP threshold may be suboptimal in some scenarios and some UEs may be receiving the SSB with an RSRP below the threshold (and hence allowed to perform repetitions); even if they will not be transmitting the PRACH at maximum output power as their actual available power is larger than the expected (from gNB) UE maximum output power used to set the SSB-RSRP threshold. This may have an impact on network performance, since even UEs not in need of PRACH repetitions (i.e. UEs not at maximum output power and able to meet the PRACH link budget requirements) will be transmitting PRACH with repetitions increasing their access delay and occupying the already scarce resources for PRACH repetitions.

With features as described herein, methods may be provided for enabling a UE to transmit PRACH repetitions for predetermined circumstances such as, for example, only when the UE output power is above a certain threshold. In particular, with one type of example, a set may be defined of one or more conditions to be observed by the UE on its output power so that a UE would be able to transmit PRACH with repetitions only in the case it has reached the certain threshold; even if the SSB-RSRP measured by the UE is below the configured SSB-RSRP threshold (as described above). Additionally, a procedure may be provided for the UE to adapt the measured value of the measured SSB-RSRP at different PRACH attempts; eventually adapting the number of transmitted PRACH repetitions. Additionally, or alternatively, a procedure may be provided for the UE to adapt the configured SSB-RSRP thresholds at different PRACH attempts; eventually adapting the number of transmitted PRACH repetitions.

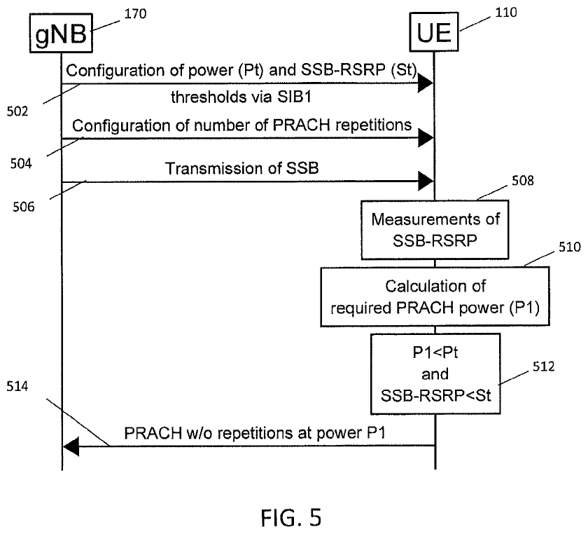

The following aspects characterize examples regarding UE transmission of PRACH repetitions subject with regard to a further condition of UE output power being above a certain UE output power threshold.
In one example embodiment, the UE output power threshold is configured by the network via higher layer signalling (e.g. SIB1) and determined by the UE as such value
In one example embodiment, multiple UE output power thresholds are configured by the network via higher layer signalling (e.g. SIB1), each threshold associated to a UE power class (i.e. UE maximum output power for each respective class), and the UE determines the threshold to be used as the one related to the power class for that particular UE
In one example embodiment, the one or multiple UE output power threshold(s) are specified, and the UE determines the UE output power threshold to be used via a specification
In another example embodiment, the UE output power threshold(s) are configured or specified as absolute power values (one for each power class in case)
In another example embodiment, the UE output power threshold(s) are configured or specified as relative power values, from the maximum power supported by a certain UE power class (e.g. X dB from 23 dBm for PC3).
In another example embodiment, the UE output power threshold(s) are configured or specified as relative power values; such as from a reference value that could itself be configured or specified
In one example embodiment, the condition on UE output power may be additional and complementary to the condition on the measured SSB-RSRP. The UE transmits PRACH repetitions only if the output power is above the determined UE output power threshold. With this example, two conditions are needed for there to be multiple PRACH transmissions (PRACH repetitions). One condition is that SSB-RSRP is below a threshold, and the other condition is that the output power is above another different threshold. If both conditions are satisfied, the UE may transmit PRACH repetitions (multiple PRACH transmissions). If one of the two conditions is not satisfied, the UE may transmit PRACH merely once as indicated by 514 in FIG. 5 without repetitions.

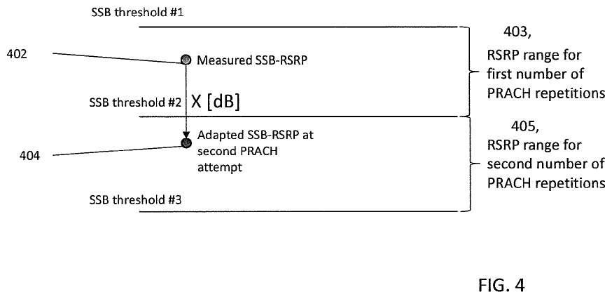

As noted above, the UE may be provided with a procedure to adapt the measured value of the measured SSB-RSRP at different PRACH attempts to use a new modified value, even if the actual SSB-RSRP value measured at the UE across the different PRACH attempts is not changed. This is advantageous especially in the case multiple SSB-RSRP thresholds are configured and multiple values of multiple PRACH transmissions are configured. The UE determination of the number of PRACH repetitions, for a given PRACH attempt, may be based on a value of power difference [such as in dB] used by the UE to modify (i.e. increase or decrease) the measured value of SSB-RSRP. In other words, for a given PRACH attempt, the UE may subtract the value of power difference from the originally measured SSB-RSRP, check in which RSRP range (as for example illustrated in FIG. 3 and associated to a number of PRACH repetitions) the new calculated value falls, and transmit PRACH with the newly determined number of repetitions. A sketch of the method is shown in FIG. 4 (SSB-RSRP adaptation procedure at second PRACH attempt. X [dB] refers to the so called “power difference” value in the second example embodiment). The adaptation procedure is also discussed in further detail below.
The assumption here is that when the UE fails a PRACH attempt, the UE performs power ramp-up on its transmission power based on already standardized procedure. So, the required power for PRACH (and transmitted by the UE, if not already at maximum power) increases with the number of PRACH attempts. In addition, we assume that multiple values of PRACH repetitions are configured by the gNB, each value associated to a range of RSRP values, as described above.
In one example embodiment, the value of power difference is determined by the UE as the difference between the required or determined power for the current PRACH attempt (calculated via the power control algorithm and power ramp up procedure) and the configured/determined UE output power threshold
In another example embodiment, the value of power difference is fixed for all PRACH attempts and configured by the network via higher layer signalling.
In another example embodiment, the value of power difference is not fixed for all PRACH attempts but an initial value may be configured by the network via higher layer signalling. The initial value may then be adjusted by the UE as a function of the PRACH attempt. For example, a UE may be using X dB for the second PRACH attempt, X+Z dB for the third PRACH attempt, and so on.

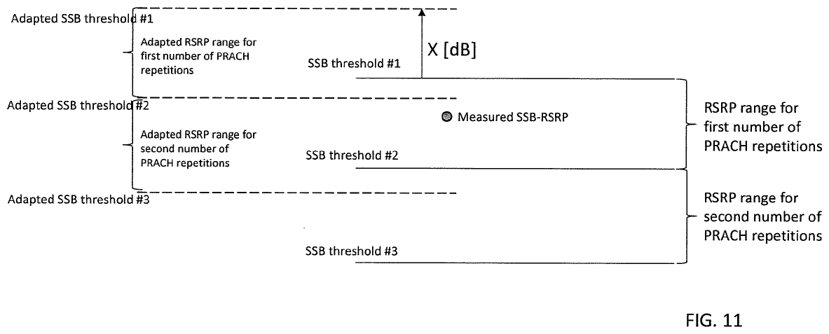

As noted above, the UE may be provided with a procedure to adapt the values of the configured SSB-RSRP threshold(s) at different PRACH attempts to use a new modified value. This is advantageous especially in the case multiple SSB-RSRP thresholds are configured and multiple values of multiple PRACH transmissions are configured and, compared to that described in the above paragraph, in the case the measured SSB-RSRP at a second PRACH attempt has changed. The UE determination of the number of PRACH repetitions, for a given PRACH attempt, may be based on a value of power difference [such as in dB] used by the UE to modify (i.e. increase or decrease) the configured SSB-RSRP threshold(s). In other words, for a given PRACH attempt, the UE may add the value of power difference from the configured SSB-RSRP threshold(s), check in which RSRP range the measured SSB-RSRP falls, and transmit PRACH with the newly determined number of repetitions. A sketch of an example alternative method is shown in FIG. 11 (SSB-RSRP thresholds adaptation procedure at second PRACH attempt). X [dB] refers to the so called “power difference” value in the second example embodiment). The adaptation procedure is also discussed in further detail below.
The assumption here is that when the UE fails a PRACH attempt, the UE performs power ramp-up on its transmission power based on already standardized procedure. So, the required power for PRACH (and transmitted by the UE, if not already at maximum power) increases with the number of PRACH attempts. In addition, we assume that multiple values of PRACH repetitions are configured by the gNB, each value associated to a range of RSRP values, as described above.
In one example embodiment, the value of power difference is determined by the UE as the difference between the required or determined power for the current PRACH attempt (calculated via the power control algorithm and power ramp up procedure) and the configured/determined UE output power threshold
In another example embodiment, the value of power difference is fixed for all PRACH attempts and configured by the network via higher layer signalling.
In another example embodiment, the value of power difference is not fixed for all PRACH attempts but an initial value may be configured by the network via higher layer signalling. The initial value may then be adjusted by the UE as a function of the PRACH attempt. For example, a UE may be using X dB for the second PRACH attempt, X+Z dB for the third PRACH attempt, and so on.

Referring also to FIGS. 5-7, flowcharts are shown for example implementations. The following are various example steps in the flowcharts between the gNB 170 and the UE 110.

Step 1: Configuration of the UE output power threshold (Pt) and SSB-RSRP threshold (St) via higher layer signalling (e.g. SIB1) as shown by step 502.
a. In this example implementation we are assuming gNB configures only one SSB-RSRP threshold and only one UE output power threshold (e.g. for one power class). Without loss of generality, operation can be extended to multiple configured thresholds.
b. At the same time, as shown by 504, the gNB may configure a number of PRACH repetitions to be performed in case conditions are satisfied. Assuming that only one SSB-RSRP threshold is configured, the example may comprise only one number of repetitions to be configured. In the case multiple SSB-RSRP thresholds are configured, different numbers of PRACH repetitions may be configured such as, for example, shown in FIG. 3.

Step 2: SSB periodic transmission, with period for example equal to 20 milliseconds, may follow a standardized procedure as shown by 506. Different SSB indexes may optionally be transmitted by the gNB in a so-called SSB burst.

Step 3: Measurement of SSB-RSRP by the UE for the SSB index chosen as the best, for example with largest SSB-RSRP, by the UE may be provided as shown by 508. However, the choice of the best index is not relevant in the context of features as described herein.

Step 4: The UE calculation of required power (P1) for PRACH transmission in the first attempt following the standardized procedure is shown at 510.
a. An example of the formula for power control for PRACH is specified in 3GPP TS 38.213

Step 5: In this example, as shown at 512, the UE may compare P1 with the configured threshold Pt, and also compare the measured SSB-RSRP with the configured threshold St. With the determination that the measured SSB-RSRP is less than (<) St.

For the example shown in FIG. 5, with P1<Pt (as by example), the UE may set the number of PRACH transmissions to 1; even if the measured SSB-RSRP is below the threshold St. The one (1) PRACH transmission may be set at the calculated power P1. The UE may proceed to Step 6 (514).

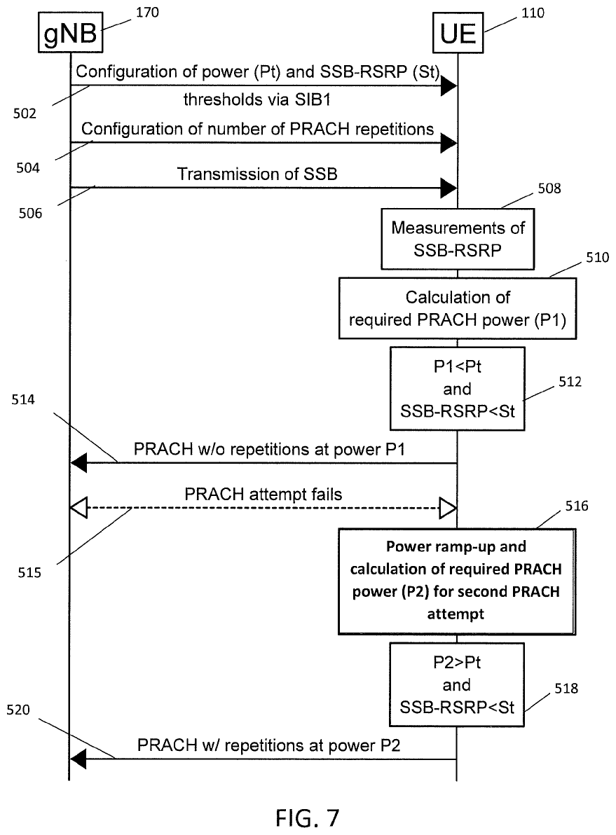

Step 6: As shown at 514, the UE may transmit PRACH without repetitions (only 1 transmission). If the UE realizes that the PRACH attempt fails as indicated by 515 in FIG. 7 because, for example, the UE has not received a Msg2 within a suitable amount of time such as the configured ra-response Window, the UE may proceed to Step7 (516, 518) as further described below and use an adaptation procedure.

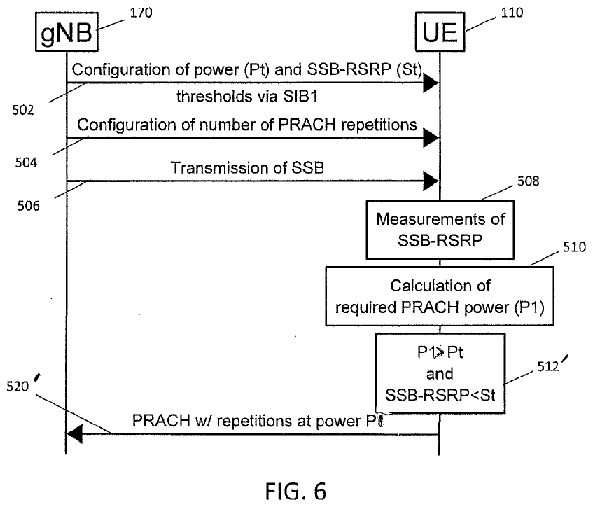

Referring also to FIG. 6, if the UE 110 determines that P1>Pt, as indicated by 512′ in FIG. 6, the UE may send PRACH with repetitions at the calculated power P1 as indicated with 520′. In the case Pt is larger than or equal to the UE maximum output power, UE may send PRACH with repetitions at power Pt. Sending repetitions of PRACH is also known as transmitting PRACH in multiple transmissions or sending PRACH multiple times. The UE may use a predetermined number of repetitions, such as the number of repetitions indicated from the network node (gNB 170) at 504 for example.

Referring also to FIG. 7, if a PRACH attempt is determined to have failed as indicated by 515, a power ramp up process may be used.

Step 7: In this example, Step 7 would occur with a detected failure at 515. As shown at 516 and 518, the UE may perform power ramp-up based on the standardized procedure (3GPP TS 38.321) and increase the transmission power by a value delta_P (AP) (such as a configured value for example) for the second PRACH attempt such that P2=P1+delta_P
a. If P2>Pt (as by example), the UE may go to Step8(520)
b. If P2 is still less than Pt (P2<Pt), the UE may go back to 514, to transmit the PRACH without repetitions at power P2. If there is still a PRACH attempt failure 515 the process may proceed to 516 and 518 again; increasing P2 to another power P3. After 518 again, if the process is still not able to proceed to 520, the process may repeat again as many times (n) as needed and possible.

Step 8: As shown at 520, once it is determined that both conditions are met (P2>Pt and SSB-RSRP<St), the UE may transmit PRACH with the configured number of repetitions and with the determined power P2 or P3 or P(n).

In regard to the adaptation procedure, adaptation may use both increasing power and increasing the number of repetitions. Step7 mentions performing power ramp up based on the standardized procedure. Also, FIG. 4 shows a new calculated SSB-RSRP 404 being calculated for a subsequent (second) PRACH attempt. As seen in FIG. 4, the measured SSB-RSRP 402 was determined to be in a first RSRP range 403 which would provide a first number of PRACH repetitions. The new calculated value for the calculated SSB-RSRP 404 shown in FIG. 4 results in the calculated value falling within the second RSRP range 405 for a second different number of PRACH repetitions; the second different number of repetitions being larger than the first number of PRACH repetitions. So, the measured value of SSB-RSRP is reduced to a new calculated value to then compare the new calculated value to St again (where St in this case is a set of multiple SSB-RSRP thresholds rather than a single threshold as in the examples of FIG. 5, FIG. 6 and FIG. 7), and then this results in the new calculated value (see FIG. 4) to provide a different larger second number of PRACH repetitions which can be used to proceed to step 7 rather than going to step 6. It should be noted that the described procedure of SSB-RSRP adaptation is merely optional and might not be provided. In addition, other forms of SSB-RSRP adaptation procedures could be provided.

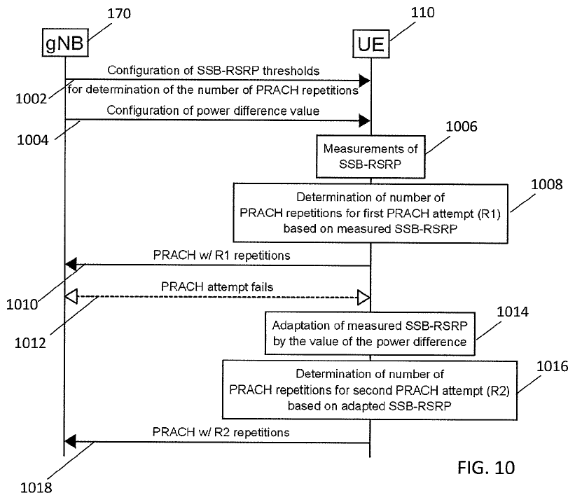

Referring to FIG. 10, a flowchart is shown for an example implementation of the SSB-RSRP adaptation procedure, in the case the measured SSB-RSRP is adapted. In the case the SSB-RSRP configured thresholds are adapted as by some embodiments, the procedure may be the same as the flowchart in FIG. 10 with the changes that the adaptation in 1014 is on the configured SSB-RSRP thresholds rather than the measured SSB-RSRP and the determination of the number of multiple PRACH transmissions in 1016 is based on the adapted SSB-RSRP thresholds. The following are various example steps in the flowchart between the gNB 170 and the UE 110.

Step 1: gNB (170) configures the SSB-RSRP thresholds for determination of the number of PRACH repetitions and transmits the configuration to the UE (110) as indicated by 1002. One example implementation of such configuration is illustrated with FIG. 3.

Step 2: the gNB (170) configures a value of power difference for the SSB-RSRP adaptation procedure at different PRACH attempts and transmits the configuration to the UE (110) as indicated by 1004. In this example implementation we are assuming that the value is configured by gNB, but in other example embodiments it could be determined by the UE based on its calculated power for PRACH transmission based on the power control algorithm and the power ramp up procedure.

Step 3: Measurement of the SSB-RSRP, for the SSB index chosen as the best, for example with largest SSB-RSRP, by the UE (110) may be provided or determined as shown by 1006.

Step 4: Determination of the number of multiple PRACH transmissions for first PRACH attempt by the UE (110) may be provided or determined as shown by 1008. Such determination may be based on the measured SSB-RSRP in 1006 and the configured SSB-RSRP thresholds in 1002. For example, the UE may determine a number R1 of multiple PRACH transmissions.

Step 5: UE transmits the R1 multiple PRACH transmissions as illustrated with 1010.

Step 6:1012 illustrates when a PRACH attempt (i.e. first PRACH attempt) fails.

Step 7: Adaptation of the measured SSB-RSRP in 1006 may be provided as illustrated in 1014. The adaptation may be based on the value of the power difference. In one example, the measured SSB-RSRP in 1006 is decreased by the amount of power difference value provided in 1004.

Step 8: The adapted SSB-RSRP value may be used for determination of the number of PRACH multiple transmissions for the second PRACH attempt in 1016. The UE 110 may compare the adapted SSB-RSRP value to the configured SSB-RSRP thresholds in 1002, and determine the value R2 of multiple PRACH transmissions.

Step 9: The UE 110 may transmit R2 multiple PRACH transmissions as illustrated in 1018.

It should be noted that, even if in the example of FIG. 10 the SSB-RSRP adaptation procedure stops at the second PRACH attempt for the sake of clarity, it should not be assumed that this is a generic way of operation. For example, if the second PRACH attempt 1018 fails again, in the third PRACH attempt the adapted SSB-RSRP value from 1014 may be again decreased by the power difference value to provide a new value of the adapted SSB-RSRP value to be used for determination of the number of multiple PRACH transmissions for the third PRACH attempt. The same procedure could then be followed for subsequent PRACH attempts.

It should be further noted that, in the case the value of the power difference increases as a function of the PRACH attempt as by embodiments of this application, the adaptation of the measured SSB-RSRP may be based either on the latest adapted SSB-RSRP or the measured SSB-RSRP. For example, in reference to FIG. 10, if the configured power difference value is X, 1014 may provide the adapted SSB-RSRP value as the measured SSB-RSRP minus X. If the PRACH transmission fails again, and a third PRACH attempt occurs, the configured power difference value may be increased by Z (i.e. X+Z) and the value (X+Z) may be removed from either the adapted SSB-RSRP in 1014 or the measured SSB-RSRP in 1006.

It should be noted that one should distinguish between the transmission power (what's called P1/P2) and the SSB-RSRP received and measured power. The adaptation process refers mostly to the SSB-RSRP received power, but may be linked to the power ramp up procedure in the case the value of power difference is not configured by gNB but determined by the UE. By increasing the power needed for transmission via the power ramp-up procedure (even if UE is then not able to deliver such power), the difference value between such increased power and the power threshold Pt may increase to bring the SSB-RSRP lower; enabling a larger number of repetitions. With features as described herein, the transmission power may be increased at each re-attempt following the power ramp up procedure. This would eventually cause the difference value to be larger and larger, and so to decrease the SSB-RSRP more and more, leading to a larger number of repetitions. With reference to FIG. 10, the larger difference value for a possible third PRACH attempt could either be applied to the adapted SSB-RSRP in 1014 or the measured SSB-RSRP in 1006.

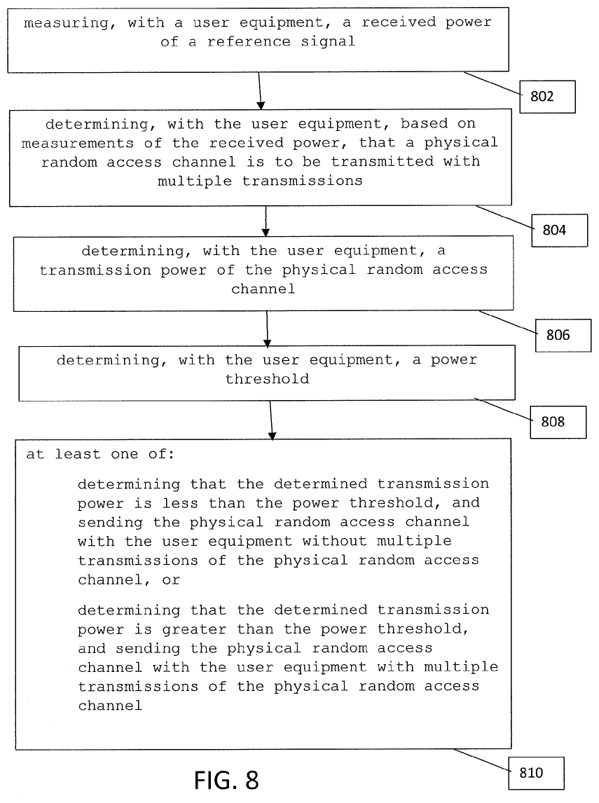

Referring also to FIG. 8, in accordance with one example, an example method is provided comprising: measuring, with a user equipment, a received power of a reference signal as indicated by block 802; determining, with the user equipment, based on the measurement of the received power, that a physical random access channel is to be transmitted with multiple transmissions as indicated by block 804; determining, with the user equipment, a transmission power of the physical random access channel as indicated by block 806; determining, with a the user equipment, a power threshold as indicated by block 808; and as indicated by block 810 at least one of:
determining that the determined transmission power is less than the power threshold, and sending the physical random access channel with the user equipment without multiple transmissions of the physical random access channel, or
determining that the determined transmission power is greater than the power threshold, and sending the physical random access channel with the user equipment with multiple transmissions of the physical random access channel.

The method may further comprise, based upon a random access procedure failure, increasing the transmission power with the user equipment, and determining an increase in a number of the multiple transmissions of the physical random access channel. The determining of the increase in the number of the multiple transmissions of the physical random access channel may be based, at least partially, upon the increased transmission power being larger than the power threshold. The determining of the power threshold may comprise receiving the power threshold from a network node. The method may further comprise determining a different power threshold comprises receiving the different power threshold from a network node. The different power threshold may be a synchronization signal block reference signal received power (SSB-RSRP) threshold. The power threshold may be a user equipment output power threshold. The determining of the power threshold may comprise receiving multiple power thresholds and selecting the power threshold from the received multiple power thresholds. It should be noted that the determining steps noted above do not need to be in any particular order or sequence. The order or sequence of the steps may be altered or occur with any suitable type or order or sequence.

The selecting of the power threshold may be based, at least partially, upon a power class of the user equipment. The selecting of the power threshold may be based, at least partially, upon a predetermined setting or specification in the user equipment. The determining of the power threshold may comprise modifying a power threshold value to determine the power threshold. The power threshold value may be received from a network node and the power threshold value may be reduced by the user equipment by a determined amount to provide the power threshold. The determining of the power threshold may comprise use of a power value relative to a maximum power supported by the user equipment or a power class of the user equipment. The determining of the power threshold may comprise use of a power value relative to a reference power value. The method may further comprise: determining a first value of a first measured power; reducing the first value by a second value to form a third new value; and using the third new value to determine the number of physical random access channel multiple transmissions. The second value may be a power difference determined by the user equipment; determined by the UE as a difference between the necessary power for PRACH transmission and the available power at the UE. The second value may be a power difference received at the user equipment from a network node. The determining of the transmission power of the physical random access channel may be based on a power control algorithm. The determining of the transmission power of the physical random access channel may comprise calculating the transmission power of the physical random access channel. The reference signal may be a synchronization reference signal or a channel state information reference signal.

An example embodiment may be provided with an apparatus comprising: at least one processor; and at least one non-transitory memory storing instructions that, when executed with the at least one processor, cause the apparatus to perform: measuring, with the apparatus, a received power of a reference signal; determining, with the apparatus, based on the measurement of the received power, that a physical random access channel is to be transmitted with multiple transmissions; determining, with the apparatus, a transmission power of the physical random access channel; determining, with the apparatus, a power threshold; and at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

The apparatus may be a user equipment. The instructions, when executed with the at least one processor, may cause the apparatus to perform, based upon a random access procedure failure, increasing the transmission power with the apparatus, and determining an increase in a number of the multiple transmissions of the physical random access channel. The determining of the increase in the number of the multiple transmissions of the physical random access channel may be based, at least partially, upon the increased transmission power being larger than the power threshold. The determining of the power threshold may comprise receiving the power threshold from a network node. The power threshold may be a user equipment output power threshold. The determining of the power threshold may comprise receiving multiple power thresholds and selecting the power threshold from the received multiple power thresholds. The selecting of the power threshold may be based, at least partially, upon a power class of the apparatus. The selecting of the power threshold may be based, at least partially, upon a predetermined setting or specification in the apparatus. The determining of the power threshold may comprise modifying a power threshold value to determine the power threshold. The power threshold value may be received from a network node and the power threshold value may be reduced by the apparatus by a determined amount to provide the power threshold. The determining of the power threshold may comprise use of a power value relative to a maximum power supported by the apparatus or a power class of the apparatus. The determining of the power threshold may comprise use of a power value relative to a reference power value. The determining of the transmission power of the physical random access channel may be based on a power control algorithm. The determining of the transmission power of the physical random access channel may comprise calculating the transmission power of the physical random access channel. The reference signal may be a synchronization reference signal or a channel state information reference signal.

An example embodiment may be provided with a non-transitory program storage device readable by an apparatus, tangibly embodying a program of instructions executable with the apparatus for performing operations, the operations comprising: measuring, with the apparatus, a received power of a reference signal; determining, with the apparatus, based on the measurement of the received power, that a physical random access channel is to be transmitted with multiple transmissions; determining, with the apparatus, a transmission power of the physical random access channel; determining, with the apparatus, a power threshold; and at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

An example embodiment may be provided with an apparatus comprising: means for measuring, with the apparatus, a received power of a reference signal; means for determining, with the apparatus, based on the measurement of the received power, that a physical random access channel is to be transmitted with multiple transmissions; means for determining, with the apparatus, a transmission power of the physical random access channel; means for determining, with the apparatus, a power threshold; and means for, at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

An example embodiment may be provided with an apparatus comprising: circuitry configured for measuring, with the apparatus, a received power of a reference signal; circuitry configured for determining, with the apparatus, based on the measurement of the received power, that a physical random access channel is to be transmitted with multiple transmissions; circuitry configured for determining, with the apparatus, a transmission power of the physical random access channel; circuitry configured for determining, with the apparatus, a power threshold; and circuitry configured for, at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

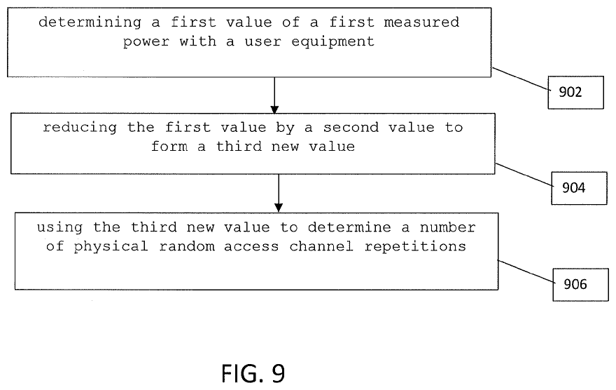

Referring also to FIG. 9, an example method may be provided comprising: determining a first value of a first measured power with a user equipment as indicated by block 902; reducing the first value by a second value to form a third new value as indicated by block 904; and using the third new value to determine a number of physical random access channel multiple transmissions as indicated by block 906.

The second value may be a power difference determined by the user equipment. The second value may be a power difference determined received at the user equipment from a network node. The method may further comprise: determining, with the user equipment, a first power threshold and a second different power threshold; determining that a first measured power is less than the third new value; and at least one of:
determining that a second calculated power is less than the second different power threshold, and sending a physical random access channel with the user equipment without a repetition of the physical random access channel based upon the determining that the third new value is less than the first power threshold and based upon the determining that the second calculated power is less than the second different power threshold, or
determining that the second calculated power is greater than the second different power threshold, and sending the physical random access channel with the user equipment with multiple transmissions based upon the determining that the third new value is less than the first power threshold and based upon the determining that the second calculated power is greater than the second different power threshold.

In an example embodiment, a method may be provided comprising determining, with a user equipment, a first power threshold and a second different power threshold; determining that a first measured power is less than the first power threshold; and at least one of:
determining that a second calculated power is less than the second different power threshold, and sending a physical random access channel with the user equipment without a repetition of the physical random access channel based upon the determining that the first measured power is less than the first power threshold and based upon the determining that the second calculated power is less than the second different power threshold, or
determining that the second calculated power is greater than the second different power threshold, and sending the physical random access channel with the user equipment with at least one repetition of the physical random access channel based upon the determining that the first measured power is less than the first power threshold and based upon the determining that the second calculated power is greater than the second different power threshold.
   The second power is the UE output power, which may be calculated via the power control formula for PRACH as defined in 3GPP TS 38.213.

With features as described herein, an example embodiment may be provided comprising a SSB-RSRP adaptation where, rather than the measured SSB-RSRP, the SSB-RSRP thresholds are adapted. This may have advantages in cases where the measured SSB-RSRP changes substantially at different PRACH attempts.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1-41. (canceled)

42. An apparatus comprising:
at least one processor; and
at least one memory storing instructions that, when executed with the at least one processor, cause the apparatus to perform:
measuring, with the apparatus, a received power of a reference signal;
determining, with the apparatus, based on the measurement of the received power, that a physical random access channel is to be transmitted with multiple transmissions;
determining, with the apparatus, a transmission power of the physical random access channel;
determining, with the apparatus, a power threshold; and
at least one of:
determining that the determined transmission power is less than the power threshold, and sending the physical random access channel with the apparatus without multiple transmissions of the physical random access channel, or
determining that the determined transmission power is greater than the power threshold, and sending the physical random access channel with the apparatus with multiple transmissions of the physical random access channel.

43. The apparatus as claimed in claim 42, where the instructions, when executed with the at least one processor, cause the apparatus to perform, based upon a random access procedure failure, increasing the transmission power with the apparatus, and determining an increase in a number of the multiple transmissions of the physical random access channel.

44. The apparatus as claimed in claim 43, where the determining of the increase in the number of the multiple transmissions of the physical random access channel is based, at least partially, upon the increased transmission power being larger than the power threshold.

45. The apparatus of claim 42, where the determining of the power threshold comprises receiving the power threshold from a network node.

46. The apparatus of claim 42, where the power threshold is a user equipment output power threshold.

47. The apparatus of claim 42, where the determining of the power threshold comprises receiving multiple power thresholds and selecting the power threshold from the received multiple power thresholds.

48. The apparatus of claim 47, where the selecting of the power threshold is based, at least partially, upon a power class of the apparatus.

49. The apparatus of claim 47, where the selecting of the power threshold is based, at least partially, upon a predetermined setting or specification in the apparatus.

50. The apparatus of claim 42, where the determining of the power threshold comprises modifying a power threshold value to determine the power threshold.

51. The apparatus of claim 50, where the power threshold value is received from a network node and the power threshold value is reduced by the apparatus by a determined amount to provide the power threshold.

52. The apparatus of claim 42, where the determining of the power threshold comprises use of a power value relative to a maximum power supported by the apparatus or a power class of the apparatus.

53. The apparatus of claim 42, where the determining of the power threshold comprises use of a power value relative to a reference power value.

54. The apparatus of claim 42, where the determining of the transmission power of the physical random access channel is based on a power control algorithm.

55. The apparatus of claim 42, where the determining of the transmission power of the physical random access channel comprises calculating the transmission power of the physical random access channel.

56. The apparatus of claim 42, where the reference signal is a synchronization reference signal or a channel state information reference signal.

57. An apparatus comprising:
at least one processor; and
at least one memory storing instructions that, when executed with the at least one processor, cause the apparatus to perform:
determining a first value of a first measured power;
reducing the first value by a second value to form a third new value; and
using the third new value to determine a number of physical random access channel multiple transmissions.

58. The apparatus of claim 57, where the second value is a power difference determined by the apparatus.

59. The apparatus of claim 57, where the second value is a power difference determined received at the apparatus from a network node.

60. The apparatus of claim 57, where the instructions, when executed with the at least one processor, cause the apparatus to perform:
determining a first power threshold and a second different power threshold;
determining that a first measured power is less than the third new value;
at least one of:
determining that a second calculated power is less than the second different power threshold, and sending a physical random access channel without a repetition of the physical random access channel based upon the determining that the third new value is less than the first power threshold and based upon the determining that the second calculated power is less than the second different power threshold, or
determining that the second calculated power is greater than the second different power threshold, and sending the physical random access channel with multiple transmissions based upon the determining that the third new value is less than the first power threshold and based upon the determining that the second calculated power is greater than the second different power threshold.

61. An apparatus comprising:
at least one processor; and
at least one memory storing instructions that, when executed with the at least one processor, cause the apparatus to perform:
determining a first power threshold and a second different power threshold;
determining that a first measured power is less than the third new value;
at least one of:
determining that a second calculated power is less than the second different power threshold, and sending a physical random access channel without a repetition of the physical random access channel based upon the determining that the third new value is less than the first power threshold and based upon the determining that the second calculated power is less than the second different power threshold, or
determining that the second calculated power is greater than the second different power threshold, and sending the physical random access channel with multiple transmissions based upon the determining that the third new value is less than the first power threshold and based upon the determining that the second calculated power is greater than the second different power threshold.
